(19) United States
(12) Patent Application Publication
(10) Pub. No.: US 2026/0344625 A1
(43) Pub. Date: Nov. 5, 2026

(54) A SYSTEM ARRANGED FOR CONTROLLING BIRDS LAYING EGGS IN A LAYING NEST

(71) Applicant: SIGNIFY HOLDING B.V., EINDHOVEN (NL)

(72) Inventors: JAEHAN KOH, CHESTNUT HILL, MA (US); MATHAN KUMAR GOPALSAMY, MEDFORD, MA (US); PETER DEIXLER, ARLINGTON, MA (US); JEFFREY JOSEPH RODNY, WOBURN, MA (US); EVREN ÖZCAN, EINDHOVEN (NL)

(21) Appl. No.: 19/487,017

(22) PCT Filed: May 17, 2024
(86) PCT No.: PCT/EP2024/063811

§ 371 Date: Nov. 24, 2025

Related U.S. Application Data
(60) Provisional application No. 63/469,565, filed on May 30, 2023.

(30) Foreign Application Priority Data
Jun. 16, 2023 (EP) 23179694.7

(51) Int. Cl. A01K 31/16; A01K 31/22; A01M 29/10

(52) U.S. Cl. CPC A01K 31/16; A01K 31/22; A01M 29/10

(57) ABSTRACT

The invention provides a system arranged for controlling birds laying eggs in a laying nest, wherein the system comprises: an interior light source for illuminating an interior of the laying nest; a sensor for detecting a parameter related to a first bird in the laying nest; a controller configured to: (i) determine a first condition based on the detected parameter, wherein the first condition is indicative of the first bird being present in the laying nest and no longer laying eggs in the laying nest; (ii) control the interior light source to start illuminating the interior of the laying nest with a bird repelling lighting characteristic upon determining said first condition.

### FIELD OF THE INVENTION

The invention relates to a system arranged for controlling birds laying eggs in a laying nest. The invention further relates to a corresponding method of controlling birds laying eggs in a laying nest, and to a computer program product. The invention further relates to a luminaire. The invention further relates to a laying nest.

### BACKGROUND OF THE INVENTION

Poultry farming is relevant for world food production, in particular for producing meat and eggs. However, each year, layer farms lose up to 15% of their egg production due to floor eggs. Floor eggs are eggs that are laid by the layer hens in non-designated areas, usually on the floor. Floor eggs are a known problem in poultry farming.

It takes manual intervention to find and remove the eggs laid on the floor. About 30% of the floor eggs are eaten by other chickens either intentionally, or after an accidental break of the floor egg. Besides reducing yield, the presence of floor eggs poses more problems, such as health hazards due to the decay of spilled content of eggs (e.g. containing bacteria), and/or such as unnecessarily allowing chickens to taste their own eggs, which makes them more susceptible to cannibalism and intentionally hunting for more eggs. Since chickens may prefer to lay eggs at locations where other eggs have already been laid by other chickens, floor eggs may even prompt the laying of more floor eggs. Hence, floor eggs are a significant problem for egg production in poultry farming.

It is known in poultry farming that hens like to lay eggs in calm enclosed spaces, which are preferably dim but not dark, and away from other birds. Therefore, commercial farms often dedicate designated areas of the barn, such as nesting boxes or laying nests, for chickens to use during laying events.

However, it appears that chickens tend to monopolize the designated areas and unnecessarily occupy the respective laying nest after laying an egg is completed. This prevents other chickens from utilizing said laying nest, thereby encouraging these other chickens to lay floor eggs, and also reducing egg yield due to an inefficient occupation of laying nests. Hence, there is a clear need to reduce the number of floor eggs, maximize the occupancy of designated areas for laying, and thereby optimize the egg production and laying process.

### SUMMARY OF THE INVENTION

It is an object of the invention to provide an improved system, which at least alleviates the problems and disadvantages mentioned above. Thereto, the invention is defined by the appended claims. Thereto, the invention provides a system arranged for controlling birds laying eggs in a laying nest, wherein the system comprises: an interior light source for illuminating an interior of the laying nest; a sensor for detecting a parameter related to a first bird in the laying nest; a controller configured to: (i) determine a first condition based on the detected parameter, wherein the first condition is indicative of the first bird being present in the laying nest and no longer laying eggs in the laying nest; (ii) control the interior light source to start illuminating the interior of the laying nest with a bird repelling lighting characteristic upon determining said first condition.

Hence, the system according to the invention comprises a controller, an interior light source, and a sensor. These components may be operatively and communicatively coupled to each other. The interior light source is arranged for illuminating the interior of the laying nest. The sensor is arranged for detecting a parameter related to a first bird in the laying nest.

The laying nest may be configured to receive birds for laying eggs. Hence, the first bird may be laying eggs in the laying nest. However, after completing laying eggs, as partly mentioned, the first bird may unnecessarily occupy the laying nest after the egg laying event is completed.

Because the controller is configured to determine a first condition indicative of the first bird being present in the laying nest and no longer laying eggs in the laying nest based on the detected parameter, the controller can advantageously control the interior light source based on determining the first condition, namely to control the interior light source to start illuminating the interior of the laying nest with a bird repelling lighting characteristic upon determining said first condition.

Therefore, the system according to the present invention detects said parameter (via the sensor), determines the first condition (via the controller), and causes the first bird to be repelled from the laying nest, or at least encouraged to leave the laying nest, with the bird repelling lighting characteristic. Hence, the controller controls the interior light source to start illuminating the interior of the laying nest with a bird repelling lighting characteristic upon determining said first condition, i.e. when the controller determines based on the detected parameter that the first bird is being present in the laying nest and (or: but) no longer laying eggs in the laying nest.

Consequently, the system according to the present invention resolves the problem of chickens unnecessarily occupying the laying nest after laying an egg is completed, thereby also mitigating the laying of floor eggs by other chicken, and thereby also further optimizing the efficiency of egg production due to an optimized occupancy of laying nests.

The interior light source may be a semiconductor light source, such as a LED light source, and/or a laser light source. The interior light source may comprise a light guide plate to outcouple the respective illumination. The interior light source may be arranged inside the laying nest.

The laying nest may alternatively be phrased as designated laying location, or laying enclosure, or laying pen. The first bird may be a laying hen. The first bird may be referred to as the first chicken.

Said interior may be an interior space of the laying nest. Said interior may comprise an interior surface of said laying nest.

In an embodiment, the bird repelling lighting characteristic may comprise one of: a light intensity of at least 15 lux; a light flicker comprising a flicker frequency of at least 1 Hertz; a light color temperature of at least 5500 Kelvin; a light spectrum comprising a dominant peak wavelength within the wavelength range between 380-480 nm. Such lighting characteristics are known to be uncomfortable and/or unattractable to birds, or their visual spectral response. The bird repelling lighting characteristic may for example comprise, preferably, a light intensity of at least 15 lux, such as most preferably a light intensity of at least 30 lux, such as for example 60 lux, or at least 100 lux. Such high intensities are repellent to laying hens laying.

Additionally, or alternatively, the bird repelling lighting characteristic may comprise at least one dynamic laser spot. A dynamic laser spot may also repel a bird, for example, when mimicking a natural predator behavior, or when triggering the bird to move due to curiosity.

The first condition indicative of the first bird being present in the laying nest and no longer laying eggs in the laying nest may be determined based on the detected parameter in various ways. For example, the first bird being present in the laying nest, and no longer laying eggs in the laying nest, may be determined (by proper approximation) via the time duration that the first bird is present in the laying nest, by comparing the duration of presence of the bird to an a priori known average time duration that the average bird takes to lay eggs in a laying nest.

Hence, in an embodiment, the sensor may be a presence sensor for detecting a presence of the first bird in the laying nest; wherein the controller is configured to determine a duration of the presence of the first bird in the laying nest based on said detected presence; wherein the controller is configured to determine the first condition indicative of the first bird being present in the laying nest and no longer laying eggs in the laying nest if the determined duration exceeds a predefined threshold duration.

Such an embodiment leverages the average time of chickens laying eggs. Hence, the duration of the first bird being present in the laying nest may be a good indicator (or: approximation) of the first bird being present in the laying nest and no longer laying eggs in the laying nest. Hence, the first condition may be determined based on the duration of the presence. A presence sensor may moreover be cost-efficient. The predefined threshold duration may be an average time duration for a bird to lay eggs in a laying nest.

In an embodiment, the predefined threshold duration may be within the range of five to ninety minutes, preferably within the range of ten to sixty minutes, most preferably within the range of fifteen to thirty minutes.

Additionally or alternatively, in an embodiment, the system may comprise a user input device configured to receive a user input specifying a duration value; wherein the controller is configured to set the predefined threshold duration to the duration value specified by the user input.

In an embodiment, the presence sensor may be one of: a camera, a PIR sensor, a single-pixel thermopile, a thermopile array, a radar sensor, a VOC sensor, a microphone, a light sensor.

In aspects, the predefined threshold duration may be based on the type of the first bird. In aspects, the system may comprise a second sensor configured to determine over a set time (e.g. at least one day, such as e.g. over a week) an average laying duration of birds laying eggs in the laying nest, wherein the controller may be configured to determine (or: obtain) said average laying duration, and determine the predefined threshold duration based on said average laying duration. For example, said predefined threshold duration may be equal to said average laying duration, or equal to the average laying duration plus an offset time (such as e.g. five minutes or ten minutes). Hence, the predetermined threshold duration may be actively adapted based on the actual conditions in the stable. Said second sensor may e.g. be an optical sensor, a camera, or a radar sensor.

In an embodiment, the controller may be configured to: (iii) control the interior light source to stop illuminating the interior of the laying nest with the bird repelling lighting characteristic when the presence sensor no longer detects the first bird being present in the laying nest. Such an embodiment is advantageous, because the interior light source does no longer illuminate the interior of the laying nest with the bird repelling lighting characteristic when the first bird is no longer detected in the laying nest, thereby not preventing a second bird to enter the laying nest to also lay an egg, thus optimizing the occupancy of the laying nest.

Additionally, in an embodiment, the controller may be configured to: (iv) control the interior light source to start illuminating the interior of the laying nest with a bird attracting lighting characteristic when the presence sensor no longer detects the first bird being in the laying nest. Such an embodiment is advantageous, because the interior light source may attract a second bird with the bird attracting lighting characteristic to enter the laying nest to also lay an egg, thus optimizing the occupancy of the laying nest.

As partly mentioned, birds (e.g. laying hens) like to lay eggs in calm enclosed spaces, which are preferably dim but not dark. Birds are also attracted by warmer color temperatures, and/or reddish light.

In an embodiment the bird attracting lighting characteristic may comprise at least one of: a light intensity of at most 15 lux; a light color temperature of at most 3000 Kelvin; a light spectrum comprising a dominant peak wavelength within the wavelength range between 625-750 nm. Alternatively, the bird attracting lighting characteristic may comprise a light spectrum comprising UV-A light.

In an alternative embodiment, phrased differently, the sensor may be a presence sensor for detecting a duration of the presence of the first bird in the laying nest, wherein the controller is configured to determine the first condition if the duration of the presence exceeds a predefined threshold duration.

Furthermore, it may be desired to illuminate the interior of the laying nest with a lighting characteristic suitable for laying eggs. Hence, in an embodiment, the controller may be configured to: (o) control the interior light source to illuminate the interior of the laying nest with an initial lighting characteristic upon detecting the presence of the first bird in the laying nest, and to stop illuminating the interior of the laying nest with the initial lighting characteristic upon determining said first condition. Said initial lighting characteristic may be an animal recipe arranged for improving an egg laying event. For example, said initial lighting characteristic may be similar to the bird attracting lighting characteristic. Thus, the initial lighting characteristic may comprise at least one of: a light intensity of at most 15 lux; a light color temperature of at most 3000 Kelvin; a light spectrum comprising a dominant peak wavelength within the wavelength range between 625-750 nm. In an embodiment, the initial lighting characteristic may comprise a dominant peak at a wavelength range between 450-480 nm and a dominant peak at a wavelength range between 515-545 nm. Such a visible light represents the trademarked Junglite light recipe of Signify/ONCE.

As mentioned, the first condition indicative of the first bird being present in the laying nest and no longer laying eggs in the laying nest may be determined based on the detected parameter in various ways. For example, the first bird being present in the laying nest, and no longer laying eggs in the laying nest, may be determined via a camera enabling common image recognition techniques.

Hence, in an embodiment, the sensor is a camera, wherein the parameter is at least one camera image related to the bird in the laying nest; wherein the controller is configured to determine the first condition based on analyzing the detected at least one camera image. In an embodiment, the camera may for example be an RGB camera or a hyper-spectral camera.

In an embodiment, the controller is configured to: (iii) control the interior light source to stop illuminating the interior of the laying nest with the bird repelling lighting characteristic when the camera no longer detects the first bird being present in the laying nest.

In an embodiment, the controller is configured to: (iv) control the interior light source to start illuminating the interior of the laying nest with a bird attracting lighting characteristic when the camera no longer detects the first bird being in the laying nest. As mentioned before, the bird attracting lighting characteristic may comprise at least one of: a light intensity of at most 15 lux; a light color temperature of at most 3000 Kelvin; a light spectrum comprising a dominant peak wavelength within the wavelength range between 625-750 nm.

In an embodiment, the interior light source comprises a housing, wherein the housing comprises the sensor and/or the controller.

In an embodiment, the sensor may be a presence sensor for detecting a presence of the first bird in the laying nest; wherein the system comprises an exterior light source for illuminating an exterior of the laying nest; wherein the controller is configured to: control the exterior light source to illuminate the exterior of the laying nest with a bird repelling lighting characteristic upon detecting the presence of the first bird in the laying nest, and to stop illuminating the exterior of the laying nest with the bird repelling lighting characteristic when the presence sensor no longer detects the first bird being present in the laying nest.

Such an embodiment may be advantageous, because by the exterior light source illuminating the exterior of the laying nest with the bird repelling lighting characteristic when the first bird is laying an egg, it is prevented that the first bird is disturbed by other birds while laying; and because by stopping to illuminate the exterior of the laying nest when the first bird is no longer detected to be present in the laying nest, it is not discouraged—but rather encouraged—that other birds may approach and enter the laying nest for laying, thereby optimizing the overall laying process and occupancy of the respective laying nest.

In a further embodiment, the controller may be configured to start illuminating the exterior of the laying nest with a bird attracting lighting characteristic when the presence sensor no longer detects the first bird being present in the laying nest. Such an embodiment encourages that other birds may approach and enter the laying nest for laying, thereby optimizing the overall laying process and occupancy of the respective laying nest.

In an alternative embodiment, phrased differently, the sensor may be a camera for detecting an activity of the first bird in the laying nest; wherein the controller is configured to determine the first condition indicative of the first bird no longer laying eggs in the laying nest based on the detected activity. Hence, the activity detected may be the parameter according to the invention. The activity may alternatively be a pre-classified activity.

It is further an object of the invention to provide an improved method, which at least alleviates the problems and disadvantages mentioned above. Thereto, the invention provides a method of controlling birds laying eggs in a laying nest, wherein the method comprises: a sensor detecting a parameter related to a first bird in the laying nest; a controller determining a first condition based on the detected parameter, wherein the first condition is indicative of the first bird being present in the laying nest and no longer laying eggs in the laying nest; the controller controlling an interior light source to start illuminating the interior of the laying nest with a bird repelling lighting characteristic upon determining said first condition. Thereby, advantages and/or embodiments applying to the system according to the invention may mutatis mutandis apply to said method according to the invention.

In an embodiment, wherein the sensor is a presence sensor for detecting a presence of the first bird in the laying nest; the method according to the invention comprises: the controller controlling the interior light source to stop illuminating the interior of the laying nest with the bird repelling lighting characteristic when the presence sensor no longer detects the first bird being present in the laying nest; AND/OR the controller controlling the interior light source to start illuminating the interior of the laying nest with a bird attracting lighting characteristic when the presence sensor no longer detects the first bird being in the laying nest.

The invention further relates to a computer program product. Hence, the invention provides a computer program product for a computing device, the computer program product comprising computer program code to perform a method of the invention when the computer program product is run on a processing unit of the computing device.

Thus, aspects of the invention may be implemented in a computer program product, which may be a collection of computer program instructions stored on a computer readable storage device which may be executed by a computer. The instructions of the present invention may be in any interpretable or executable code mechanism, including but not limited to scripts, interpretable programs, dynamic link libraries (DLLs) or Java classes. The instructions can be provided as complete executable programs, partial executable programs, as modifications to existing programs (e.g. updates) or extensions for existing programs (e.g. plugins). Moreover, parts of the processing of the present invention may be distributed over multiple computers or processors.

It is further an object of the invention to provide an improved luminaire, which at least alleviates the problems and disadvantages mentioned above. Thereto, the invention provides a luminaire suitable for a laying nest, wherein the luminaire the system according to the invention. Hence, the system according to the invention may be a luminaire. For example, a luminaire that is connectable to mains power. The luminaire may for example be a ceiling luminaire, a high-bay luminaire, a spotlight, or a pendant luminaire.

Thereto, the invention provides a luminaire for controlling birds laying eggs in a laying nest, wherein the luminaire comprises a main light source for illuminating the interior of the laying nest with an ambient light characteristic, an interior light source for illuminating an interior of the laying nest; a sensor for detecting a parameter related to a first bird in the laying nest; a controller configured to: (i) determine a first condition based on the detected parameter, wherein the first condition is indicative of the first bird being present in the laying nest and no longer laying eggs in the laying nest; (ii) control the interior light source to start illuminating the interior of the laying nest with a bird repelling lighting characteristic upon determining said first condition; wherein the controller is configured to control the main light source to illuminate the interior of the laying nest with an ambient light characteristic, wherein the ambient light is different from the bird repelling lighting characteristic. Hence, the interior light source may be an additional light source dedicated for the task of optimizing the laying process, while the main light source provides the general functions of the luminaire. The bird repelling lighting characteristic may then for example be a light flicker, or light pulse with an intensity of at least 15 lux, most preferably at least 50 lux.

It is further an object of the invention to provide an improved laying nest, which at least alleviates the problems and disadvantages mentioned above. Thereto, the invention provides a laying nest comprising an interior and the system according to the invention, wherein the interior light source of the system is configured to illuminate the interior of the laying nest.

### BRIEF DESCRIPTION OF THE DRAWINGS

The invention will now be further elucidated by means of the schematic non-limiting drawings:

FIG. 1 depicts schematically an embodiment of a system according to the invention;

FIG. 2 depicts schematically an embodiment of a system according to the invention;

FIG. 3 depicts schematically a method according to the invention;

### DETAILED DESCRIPTION OF THE EMBODIMENTS

Floor eggs are eggs that are laid by the layer hens in non-designated areas, usually on the floor. Floor eggs are a known problem in poultry farming. This problem is addressed by designating dedicated areas for chickens (i.e. hens) to lay eggs, such as laying nests. However, it appears that chickens tend to monopolize the designated areas and unnecessarily occupy the respective laying nest after laying an egg is completed. This prevents other chickens from utilizing said laying nest, thereby encouraging these other chickens to lay floor eggs, and also reducing egg yield due to an inefficient occupation of laying nests. Hence, there is a clear need to reduce the number of floor eggs, maximize the occupancy of designated areas for laying, and thereby optimize the egg production and laying process.

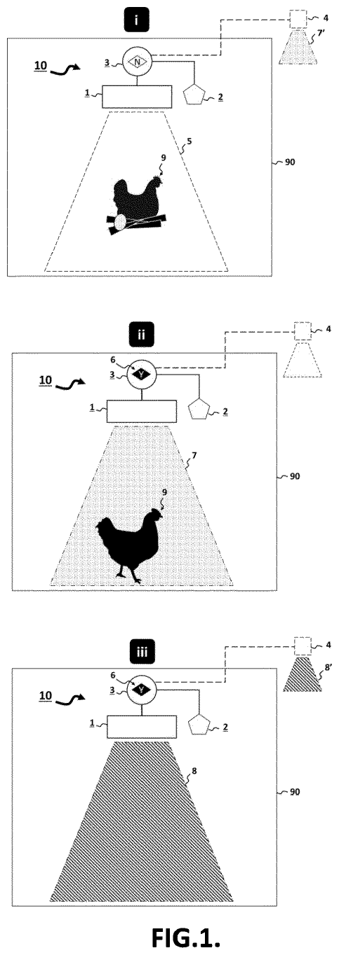

FIG. 1 depicts schematically, by non-limiting example, an embodiment of a system 10 according to the invention. The system 10 is arranged for controlling birds laying eggs in a laying nest 90. The laying nest may alternatively be phrased as an animal enclosure for laying eggs. The birds are particularly chicken, such as laying hens. The laying nest 90 is arranged to receive a first bird 9. Hence, the first bird 9 may be laying eggs in the laying nest 90. This situation may occur at a first moment in time, and is indicated with the reference (i). However, after completing laying eggs, as partly mentioned before, the first bird 9 may unnecessarily occupy the laying nest 90 after the egg laying event is completed. This may render the above-mentioned problems. This situation may occur at a second moment in time, and is indicated with the reference (ii).

Referring to FIG. 1, the system 10 according to the invention comprises an interior light source 1, a sensor 2, and a controller 3. The interior light source 1, the sensor 2, and the controller 3 are operatively and communicatively coupled to each other. Said communication may be wired and/or wireless.

The interior light source 1 illuminates the interior of the laying nest 90 with a lighting characteristic. The interior light source 1 may be a semiconductor lighting device, such as an LED lighting device or laser lighting device.

Referring to FIG. 1, the sensor 2 is configured for detecting a parameter related to the first bird 9 in the laying nest 90. Here, in the present embodiment, the sensor 2 is a presence sensor. The presence sensor 2 detects (continually or continuously) the presence of the first bird 9 in the laying nest 90. The presence sensor may for example be one of: a camera, a PIR sensor, a single-pixel thermopile, a thermopile array, a radar sensor, a VOC sensor, a microphone, a light sensor. All such sensors may detect the presence of the first bird in the laying nest. A presence sensor may also be cost efficient, e.g. a light sensor or a single pixel thermopile.

The present invention may leverage the average time of chickens laying eggs for determining whether the first bird 9 is still laying eggs within the laying nest 90 or has completed the egg laying event. Namely, the duration of the first bird 9 being present in the laying nest 90 may be a good indicator (or: approximation) of the first bird 9 being present in the laying nest 90 and no longer laying eggs in the laying nest 90.

Hence, still referring to FIG. 1, the controller 3 is configured to determine a duration of the presence of the first bird 9 in the laying nest 90 based on the detected presence (of the presence sensor 2). The duration can alternatively be phrased as a time duration. Said duration may be indicative whether or not the first bird has completed an egg laying event, because (by approximation) the detected time duration may be compared to an average time duration that an average bird takes to lay eggs in the laying nest. Such average time duration may be known a priori. If the first bird is still detected to be present after such an average time duration has passed (starting from the moment that the presence of the first bird is first detected by the sensor), it is likely that the first bird has completed the egg laying event, does no longer lay eggs, and unnecessarily occupies the laying nest.

Hence, the controller 3 is configured to determine a first condition 6 indicative of the first bird 9 being present in the laying nest 90 and no longer laying eggs in the laying nest 90 based on the detected parameter, i.e. based on the determined duration that is based on the detected presence. Namely, the controller 3 determines the first condition 6 indicative of the first bird 9 being present in the laying nest and no longer laying eggs in the laying nest if the determined duration exceeds a predefined threshold duration. Here, the predefined threshold duration is twenty minutes. The predefined threshold duration may thus be predefined in the controller, for example be pre-stored, or pre-set, or (pre-)commissioned in the controller 3. Alternatively, the predefined threshold duration may be within the range of five to ninety minutes. The predefined threshold duration may be based on the type of chicken, or the actual conditions of laying in the laying nest, or stable.

More specifically, still referring to FIG. 1, at a first moment in time (i), when the first bird 9 is present in the laying nest 90 and is still laying an egg, and thus the duration of the presence of the first bird 9 determined by the controller 3 does not exceed the predefined threshold duration, the first condition 6 is not met. However, still referring to FIG. 1, at a second moment in time (ii), when the first bird 9 is present in the laying nest 90 and is no longer laying eggs, and thus the duration of the presence of the first bird 9 determined by the controller 3 exceeds the predefined threshold duration, the first condition 6 is determined.

Additionally or alternatively, in examples, the system may comprise a user input device configured to receive a user input specifying a duration value; wherein the controller is configured to set the predefined threshold duration to the duration value specified by the user input. Said user input device may for example be a computer, a tablet, a smartphone, a building management system, a touchscreen, a smart portable device, a lighting controller, a wall switch, a laptop.

As mentioned, the controller 3 is configured to determine the first condition 6 indicative of the first bird 9 being present in the laying nest 90 and no longer laying eggs in the laying nest 90 based on the detected parameter (i.e. presence, and duration of presence derived/determined therefrom).

Still referring to FIG. 1, the controller 3 controls the interior light source 1 to start illuminating the interior of the laying nest 90 with a bird repelling lighting characteristic 7 upon determining said first condition 6.

Consequently, the system 10 according to the present invention resolves the problem of birds (i.e. chicken) unnecessarily occupying the laying nest after laying an egg is completed, thereby also mitigating the laying of floor eggs by other birds, and thereby also further optimizing the efficiency of egg production due to an optimized occupancy of laying nests.

Here, the bird repelling lighting characteristic 7 is white light having a light intensity of at least 15 lux. Such a white light having a light intensity of at least 15 lux is considered uncomfortable for a bird, particularly a laying hen, and especially when said bird repelling lighting characteristic 7 is provided to a laying nest 90 having the function of egg-laying. Here, the light intensity of the white light is at least 60 lux.

Alternatively, the bird repelling lighting characteristic may comprise one of: a light intensity of at least 15 lux; a light flicker comprising a flicker frequency of at least 1 Hertz; a light color temperature of at least 5500 Kelvin; a light spectrum comprising a dominant peak wavelength within the wavelength range between 380-480 nm. Such lighting characteristics are known to be uncomfortable and/or unattractable to birds, or their visual spectral response.

FIG. 1 further depicts a situation in which the first bird 9 has left the laying nest 90, and is thus no longer present in the laying nest 90, for example because the first bird 9 is repelled by the bird repelling lighting characteristic 7. This situation may occur at a third moment in time, and is indicated with the reference (iii).

Still referring to FIG. 1, albeit optionally, and not as a necessary feature, the controller 3 may further be configured to control the interior light source 1 to stop illuminating the interior of the laying nest 90 with the bird repelling lighting characteristic 7 when the presence sensor 2 no longer detects the first bird 9 being present in the laying nest 9. Such additional and optional features may be advantageous, because the interior light source 1 does no longer illuminate the interior of the laying nest 90 with the bird repelling lighting characteristic 7 when the first bird 9 is no longer detected in the laying nest 90, thereby not preventing a second bird to enter the laying nest 90 to also lay an egg, thus optimizing the occupancy of the laying nest 90.

Still referring to FIG. 1, albeit optionally, and not as a necessary feature, the controller 3 may further be configured to control the interior light source 1 to start illuminating the interior of the laying nest 90 with a bird attracting lighting characteristic 8 when the presence sensor 2 no longer detects the first bird 9 being present in the laying nest 90. The bird attracting lighting characteristic 8 may for example comprise at least one of: a light intensity of at most 15 lux; a light color temperature of at most 3000 Kelvin; a light spectrum comprising a dominant peak wavelength within the wavelength range between 625-750 nm. Such additional and optional features may be advantageous, because the interior light source 1 may attract a second bird with the bird attracting lighting characteristic 8 to enter the laying nest 90 to also lay an egg, thus optimizing the occupancy of the laying nest.

Still referring to FIG. 1, and in particular to the situation depicted with reference (i) at said first moment in time, albeit optionally, and not as a necessary feature, the controller 3 may control the interior light source 1 to illuminate the interior of the laying nest 90 with a lighting characteristic suitable for laying eggs. Hence, in these optional examples, the controller 3 may be configured to control the interior light source 1 to illuminate the interior of the laying nest 90 with an initial lighting characteristic 5 upon detecting the presence of the first bird 9 in the laying nest 90, and to stop illuminating the interior of the laying nest 90 with the initial lighting characteristic 5 upon determining said first condition 6.

Birds (e.g. laying hens) like to lay eggs in calm enclosed spaces, which are preferably dim but not dark. Birds are also attracted by warmer color temperatures, and/or reddish light. Hence, said initial lighting characteristic 5 may reflect such conditions. For example, similar to the mentioned bird attracting lighting characteristic 8, the initial lighting characteristic 5 may comprise at least one of: a light intensity of at most 15 lux; a light color temperature of at most 3000 Kelvin; a light spectrum comprising a dominant peak wavelength within the wavelength range between 625-750 nm. In examples, the initial lighting characteristic 5 may comprise a dominant peak at a wavelength range between 450-480 nm and a dominant peak at a wavelength range between 515-545 nm. Such a visible light represents the trademarked Junglite light recipe of Signify/ONCE.

Still referring to FIG. 1, albeit optionally, and not as a necessary feature, the system 10 according to the invention may further comprise an exterior light source 4 for illuminating an exterior of the laying nest 90. The controller 3 is then configured to control the exterior light source 4 to illuminate the exterior of the laying nest 90 with a bird repelling lighting characteristic 7′ upon detecting the presence of the first bird 9 in the laying nest. The controller 3 is then additionally configured to control the exterior light source 4 to stop illuminating the exterior of the laying nest 90 with the bird repelling lighting characteristic 7′ when the presence sensor 2 no longer detects the first bird 9 being present in the laying nest 90. See also situation with reference (ii) and/or (iii) depicted in FIG. 1.

Alternatively, the controller is configured to control the exterior light source to illuminate the exterior of the laying nest with a bird repelling lighting characteristic when the first condition is not determined, and to stop illuminating the exterior of the laying nest with the bird repelling lighting characteristic when the first condition is determined.

Such optional features to the system 10 may be advantageous, because by the exterior light source 4 illuminating the exterior of the laying nest 90 with the bird repelling lighting characteristic 7′ when the first bird 9 is laying an egg, it is prevented that the first bird 9 is disturbed by other birds while laying. Moreover, by stopping to illuminate the exterior of the laying nest 90 with the bird repelling lighting characteristic 7′ when the first bird 9 is no longer detected to be present in the laying nest, it is not discouraged—but rather encouraged—that other birds may approach and enter the laying nest 90 for laying, thereby optimizing the overall laying process and occupancy of the respective laying nest 90.

Still referring to FIG. 1, albeit optionally, and not as a necessary feature, the controller 3 controls the exterior light source 4 start illuminating the exterior of the laying nest 90 with a bird attracting lighting characteristic 8′ when the presence sensor 2 no longer detects the first bird 9 being present in the laying nest 90. Such an optional feature encourages that other birds may approach and enter the laying nest for laying, thereby optimizing the overall laying process and occupancy of the respective laying nest.

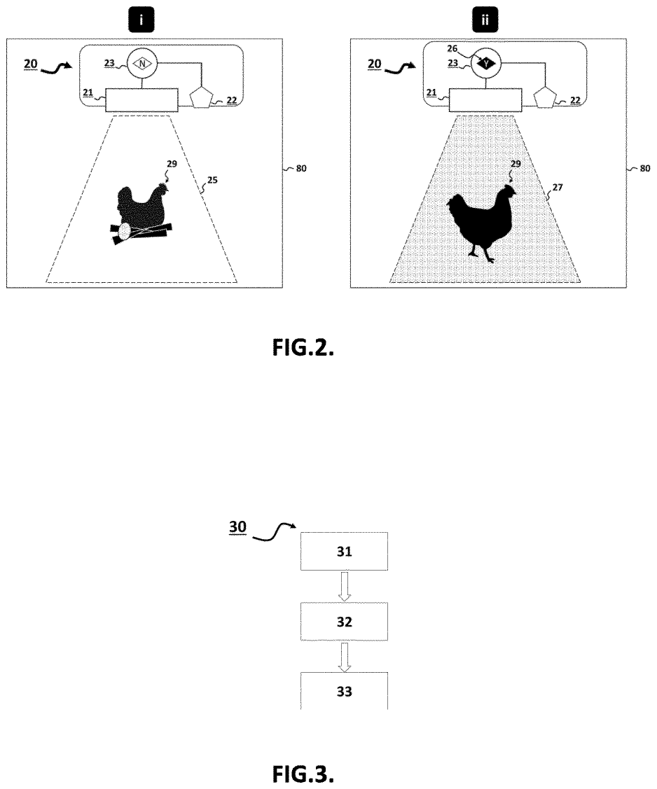

FIG. 2 depicts schematically, by non-limiting example, an embodiment of a system 20 according to the invention. The system 20 is a luminaire. The luminaire comprises (a housing comprising) an interior light source 21, a sensor 22, and a controller 23. The controller may alternatively be located external to the luminaire. The interior light source 21, the sensor 22, and the controller 23 of the luminaire 20 are operatively and communicatively coupled to each other. Said communication may be wired and/or wireless.

The luminaire 20 is mounted in a laying nest 80. The luminaire 20 is arranged for controlling birds laying eggs in a laying nest 80. The birds are particularly chicken, such as laying hens. The laying nest 80 is arranged to receive a first bird 29. Hence, the first bird 29 may be laying eggs in the laying nest 80. This situation may occur at a first moment in time, and is indicated with the reference (i). However, after completing laying eggs, as partly mentioned before, the first bird 9 may unnecessarily occupy the laying nest 90 after the egg laying event is completed. This may render the above-mentioned problems. This situation may occur at a second moment in time, and is indicated with the reference (ii).

Referring to FIG. 2, the interior light source 21 of the luminaire 20 illuminates the interior of the laying nest 80 with a lighting characteristic. The interior light source 21 may be a LED lighting device.

Referring to FIG. 2, the sensor 22 is configured for detecting a parameter related to the first bird 29 in the laying nest 80. Here, in the present embodiment, the sensor 22 is a camera 22. Here, the camera 22 is an RGB camera, but may alternatively be a hyper-spectral camera, a thermal camera, an infrared camera, etc. Said parameter is at least one camera image related to the first bird 29 in the laying nest 80. Thereby, the camera 22 detects (continually or continuously) the first bird 29 in the laying nest 80 and renders at least one camera image. The at least one camera image may be conveyed to the controller 23.

The first bird being present in the laying nest, and no longer laying eggs in the laying nest, may therefore be determined via a camera enabling common image recognition techniques.

Hence, still referring to FIG. 2, the controller 23 is configured to determine a first condition 26 indicative of the first bird 29 being present in the laying nest 80 and no longer laying eggs in the laying nest 80. Namely, the controller 23 is configured to determine the first condition 26 based on analyzing the detected at least one camera image.

Still referring to FIG. 2, the controller 23 controls the interior light source 21 to start illuminating the interior of the laying nest 80 with a bird repelling lighting characteristic 27 upon determining said first condition 26.

Consequently, the system 20 according to the present invention resolves the problem of birds (i.e. chicken) unnecessarily occupying the laying nest after laying an egg is completed, thereby also mitigating the laying of floor eggs by other birds, and thereby also further optimizing the efficiency of egg production due to an optimized occupancy of laying nests.

Still referring to FIG. 2, albeit optionally, and not as a necessary feature, the system 20 according to the invention may comprise a controller 23 that is configured to control the interior light source 21 to stop illuminating the interior of the laying nest 80 with the bird repelling lighting characteristic 27 when the camera 22 no longer detects the first bird 29 being present in the laying nest 80.

Still referring to FIG. 2, albeit optionally, and not as a necessary feature, the controller 22 may also be optionally configured to control the interior light source 21 to start illuminating the interior of the laying nest 80 with a bird attracting lighting characteristic 25 when the camera 22 no longer detects the first bird 29 being in the laying nest. As mentioned before, such a bird attracting lighting characteristic 25 may comprise at least one of: a light intensity of at most 15 lux; a light color temperature of at most 3000 Kelvin; a light spectrum comprising a dominant peak wavelength within the wavelength range between 625-750 nm.

FIG. 3 depicts a method 30 of controlling birds laying eggs in a laying nest. The method 30 may be performed by the systems according to the invention. The method 30 comprises a step 31 of a sensor detecting a parameter related to a first bird in the laying nest. The method comprises a step 32 of a controller determining a first condition based on the detected parameter, wherein the first condition is indicative of the first bird being present in the laying nest and no longer laying eggs in the laying nest. The method 30 comprises a step 33 of the controller controlling an interior light source to start illuminating the interior of the laying nest with a bird repelling lighting characteristic upon determining said first condition.

For example, in embodiments of the method, the sensor may be a presence sensor for detecting a presence of the first bird in the laying nest; the method according to the invention then comprises a step of the controller controlling the interior light source to stop illuminating the interior of the laying nest with the bird repelling lighting characteristic when the presence sensor no longer detects the first bird being present in the laying nest; AND/OR a step of the controller controlling the interior light source to start illuminating the interior of the laying nest with a bird attracting lighting characteristic when the presence sensor no longer detects the first bird being in the laying nest.

1. A system arranged for controlling birds laying eggs in a laying nest, wherein the system comprises:
an interior light source for illuminating an interior of the laying nest;
a sensor for detecting a parameter related to a first bird in the laying nest;
a controller configured to:
(i) determine a first condition based on the detected parameter, wherein the first condition is indicative of the first bird being present in the laying nest and no longer laying eggs in the laying nest;
(ii) control the interior light source to start illuminating the interior of the laying nest with a bird repelling lighting characteristic upon determining said first condition.

2. The system according to claim 1, wherein the sensor is a presence sensor for detecting a presence of the first bird in the laying nest;
wherein the controller is configured to determine a duration of the presence of the first bird in the laying nest based on said detected presence;
wherein the controller is configured to determine the first condition indicative of the first bird being present in the laying nest and no longer laying eggs in the laying nest if the determined duration exceeds a predefined threshold duration.

3. The system according to claim 2, wherein the controller is configured to:
(iii) control the interior light source to stop illuminating the interior of the laying nest with the bird repelling lighting characteristic when the presence sensor no longer detects the first bird being present in the laying nest.

4. The system according to claim 3, wherein the controller is configured to:
(iv) control the interior light source to start illuminating the interior of the laying nest with a bird attracting lighting characteristic when the presence sensor no longer detects the first bird being in the laying nest.

5. The system according to claim 4, wherein the bird attracting lighting characteristic comprises at least one of:
a light intensity of at most 15 lux;
a light color temperature of at most 3000 Kelvin;
a light spectrum comprising a dominant peak wavelength within the wavelength range between 625-750 nm.

6. The system according to claim 1, wherein the predefined threshold duration is within the range of five to ninety minutes.

7. The system according to claim 2, wherein the controller is configured to:
(o) control the interior light source to illuminate the interior of the laying nest with an initial lighting characteristic upon detecting the presence of the first bird in the laying nest, and to stop illuminating the interior of the laying nest with the initial lighting characteristic upon determining said first condition.

8. The system according to claim 2, wherein the system comprises a user input device configured to receive a user input specifying a duration value; wherein the controller is configured to set the predefined threshold duration to the duration value specified by the user input.

9. The system according to claim 1, wherein the bird repelling lighting characteristic comprises one of:
a light intensity of at least 15 lux;
a light flicker comprising a flicker frequency of at least 1 Hertz;
a light color temperature of at least 5500 Kelvin;
a light spectrum comprising a dominant peak wavelength within the wavelength range between 380-480 nm;

10. The system according to claim 1, wherein the sensor is a camera, wherein the parameter is at least one camera image related to the first bird in the laying nest;
wherein the controller is configured to determine the first condition based on analyzing the detected at least one camera image.

11. The system according to claim 10, wherein the controller is configured to:
(iii) control the interior light source to stop illuminating the interior of the laying nest with the bird repelling lighting characteristic when the camera no longer detects the first bird being present in the laying nest.

12. The system according to claim 1, wherein the interior light source comprises a housing, wherein the housing comprises the sensor and/or the controller.

13. The system according to claim 1, wherein the sensor is a presence sensor for detecting a presence of the first bird in the laying nest;
wherein the system comprises an exterior light source for illuminating an exterior of the laying nest;
wherein the controller is configured to:
control the exterior light source to illuminate the exterior of the laying nest with a bird repelling lighting characteristic upon detecting the presence of the first bird in the laying nest, and to stop illuminating the exterior of the laying nest with the bird repelling lighting characteristic when the presence sensor no longer detects the first bird being present in the laying nest.

14. A method of controlling birds laying eggs in a laying nest, wherein the method comprises:
a sensor detecting a parameter related to a first bird in the laying nest;
a controller determining a first condition based on the detected parameter, wherein the first condition is indicative of the first bird being present in the laying nest and no longer laying eggs in the laying nest;
the controller controlling an interior light source to start illuminating the interior of the laying nest with a bird repelling lighting characteristic upon determining said first condition.

15. The method according to claim 14, wherein the sensor is a presence sensor for detecting a presence of the first bird in the laying nest;
wherein the method comprises:
the controller controlling the interior light source to stop illuminating the interior of the laying nest with the bird repelling lighting characteristic when the presence sensor no longer detects the first bird being present in the laying nest; AND/OR
the controller controlling the interior light source to start illuminating the interior of the laying nest with a bird attracting lighting characteristic when the presence sensor no longer detects the first bird being in the laying nest.
